(19) United States
(12) Patent Application Publication
(10) Pub. No.: US 2019/0240807 A1
(43) Pub. Date: Aug. 8, 2019

(54) DUST HOOD FOR A GRINDING DEVICE

(71) Applicant: HILTI AKTIENGESELLSCHAFT, Schaan (LI)

(72) Inventor: Thomas BLATZ, Kaufering (DE)

(73) Assignee: HILTI AKTIENGESELLSCHAFT, Schaan (LI)

(21) Appl. No.: 16/329,791

(22) PCT Filed: Sep. 11, 2017
(86) PCT No.: PCT/EP2017/072689

§ 371 Date: Mar. 1, 2019

(30) Foreign Application Priority Data
Sep. 28, 2016 (EP) 16191042.7

(51) Int. Cl. B24B 55/10; B24B 23/02; B25F 5/02

(52) U.S. Cl. CPC B24B 55/102; B25F 5/02; B24B 23/028

(57) ABSTRACT

A dust hood for a grinding device equipped with a transmission extension housing for attaching the dust hood, the dust hood comprising a hood body for covering a circular grinding disk and comprising a skirt running around a periphery (U) of the hood body for at least partially sealing the hood body in relation to a surface (UG) which is to be machined by means of the grinding disk, and comprising a suction connection via which removed surface material can be suctioned from the hood body. The dust hood has an adjusting ring, by means of which the hood body can be adjusted relative to the transmission extension housing and/or to the adjusting ring, preferably in an axial direction (A) with respect to the rotational axis (R) of the grinding disk.

The present invention relates to a dust hood for a grinding device equipped with a gearbox extension for attaching the dust hood. The dust hood is equipped with a hood body for covering a circular grinding disk, and with a skirt extending along a periphery of the hood body for at least partially sealing the hood body with respect to a surface that is to be machined by means of the grinding disk. The dust hood has a suction connection via which removed surface material can be suctioned from the hood body.

Dust hoods of the above-mentioned type are basically known from the prior art. They are used to avoid the propagation of dust during grinding operations, among other reasons to protect the health of a user of the grinding device. It is known to equip the hood body with a skirt in the form of a brush ring or a lamellar skirt, so that the hood body terminates at the surface to be machined. When the angle grinder is placed at a slight angle on the surface to be machined, the skirt may close off a gap possibly formed between the hood body and the surface to be machined, suction of dust typically being optimal when a gap of 1 to 2 mm forms between the bust ring or lamellar skirt and the surface.

The object of the present invention is to provide a dust hood that offers improved options for use.

The object is achieved in that the dust hood has an adjusting ring by means of which the hood body may be adjusted relative to the gearbox extension and/or to the adjusting ring, preferably in the axial direction with respect to the rotational axis of the grinding disk.

The invention incorporates the finding that a grinding disk typically wears down by approximately 8 mm over its lifetime; accordingly, the height of the bust ring/lamellar skirt should be readjustable for optimal suction of dust.

The invention also incorporates the finding that dust hoods known from the prior art either do not use height adjustment at all, or use rubber lips to press the bust ring or lamellar skirt against the surface. Both of these factors result in severe wear specifically on these elements, so that the bust ring or lamellar skirt must typically be replaced along with the grinding disk. In addition, the suction result is not optimal when the bust ring or lamellar skirt rests thereon, since air cannot flow through at that location.

In a departure from the dust hoods known from the prior art, the dust hood according to the invention may be adapted to the actual state of a grinding disk. A dust hood is thus provided that offers improved options for use.

In one preferred embodiment, the skirt is designed as a lamellar skirt. Alternatively, the skirt may be designed as a brush ring or as a brush.

It has been found to be advantageous when the adjusting ring includes a guide neck that is formed on the outside of the hood body. The adjusting ring may have a grip piece to facilitate operation of the adjusting ring.

In another preferred embodiment, the hood body has a central opening through which the gearbox extension may protrude. A drive spindle to which the circular grinding disk is to be attached for the grinding operation is preferably guided through the gearbox extension.

It is particularly preferred for an adjustment thread having a thread pitch to be formed on the inner side of the adjusting ring, the adjustment thread engaging with a corresponding adjustment thread formed on the outer side of the guide neck. The engagement is preferably designed in such a way that rotating the adjusting ring about the rotational axis causes raising or lowering of the hood body relative to the gearbox extension and/or of the hood body relative to the adjusting ring. The adjustment thread and the corresponding adjustment thread are preferably designed as a trapezoidal thread.

According to one alternative embodiment, it is also possible for the adjustment thread to be fixedly or stationarily connected to the gearbox extension, so that the adjusting ring together with the hood body moves relative to the gearbox extension.

In one preferred embodiment, the dust hood has a preferably U-shaped wraparound piece. The wraparound piece may be designed to encompass a retaining collar, provided on the adjusting ring, for securing the adjusting ring to the gearbox extension. When the dust hood is properly mounted on the grinding device, the wraparound piece particularly preferably encompasses a housing collar provided on the gearbox extension. The adjusting ring is particularly preferably connected to the gearbox extension of the grinding device in a form-fit manner in the axial direction.

The wraparound piece is preferably situated so as to be removable from the gearbox extension transversely, preferably perpendicularly, with respect to the rotational axis. This facilitates disassembly of the dust hood for cleaning purposes, for example. The wraparound piece may be secured against removal from the gearbox extension by at least one retaining screw, preferably exactly two retaining screws. Alternatively or additionally, the wraparound piece may be secured against removal from the gearbox extension by a lock. The lock may be designed, for example, as a spring-loaded push button or as a pawl with snap hooks. In addition, the lock may be formed by rivets, pins, or the like.

The hood body may be infinitely adjustable. Alternatively, the hood body may be adjustable by steps. For this purpose, a preferably spring-mounted locking tappet may be provided on the adjusting ring, and/or a plurality of recesses that correspond in each case to a height step may be provided on the wraparound piece.

It has been found to be advantageous when the hood body is adjustable from an upper hood position into a lower hood position and vice versa by rotating the adjusting ring by approximately 180 degrees, wherein the upper and lower hood positions each define a stop.

It has been found to be particularly advantageous when at least one threaded recess is provided in the thread of the adjustment thread. The thread of the adjustment thread may be designed as a continuous thread. Knocking off undesirable encrusted dust is facilitated in this way. Alternatively or additionally, at least one core recess may be provided between two adjoining threads of the corresponding adjustment thread. The core recess is preferably designed as a through hole to the interior of the guide neck. This advantageously allows removal of dust from the thread.

The dust hood particularly preferably has a skirt support to which the skirt may be fixedly connected. It has been found to be advantageous when the skirt support has a detent socket that can be snapped into the hood body. The detent socket particularly preferably has at least one socket slot that may extend in parallel to the rotational axis and that preferably overlaps, at least partially, with the core recess. Removal of dust from the thread is further improved in this way.

In one particularly preferred embodiment, the hood body is designed for covering a major portion of the grinding disk. The dust hood may have a hood section that is movable along the hood body in the circumferential direction of the hood body, and that is provided for covering and uncovering a remaining portion of the grinding disk as needed. This allows an isolation mode, using the remaining portion of the grinding disk that is not covered by the hood body.

The skirt is preferably fixedly connected to the hood body. The dust hood may be free of any spring elements that act between the skirt and the hood body in the axial direction.

The object is likewise achieved by a grinding device having a gearbox extension and a dust hood of the type described above, wherein the dust hood is or may be situated on the gearbox extension.

Further advantages result from the following description of the figures. Various exemplary embodiments of the present invention are illustrated in the figures. The figures, the description, and the claims contain numerous features in combination. Those skilled in the art will also advantageously consider the features individually and combine them into further meaningful combinations.

Identical and similar components are denoted by the same reference numerals in the figures, which show the following:

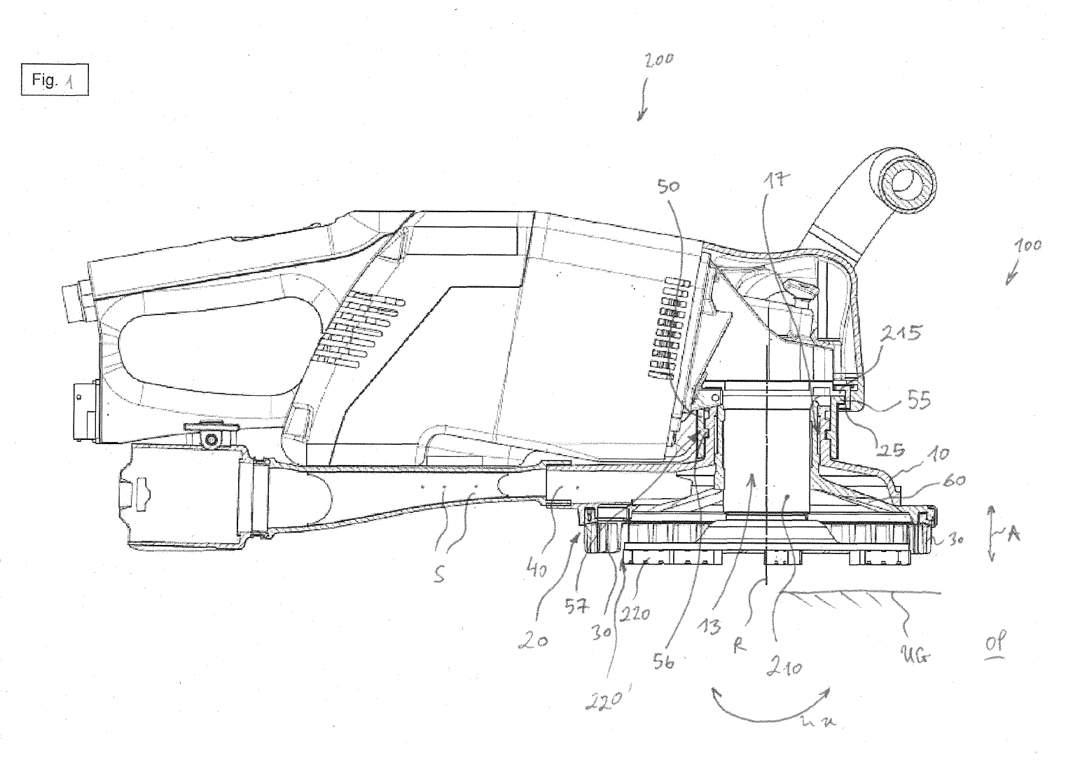

FIG. 1 shows a grinding device in the form of a diamond grinder on which a dust hood according to one preferred exemplary embodiment of the invention is situated, with an illustration of the dust hood in a sectional view;

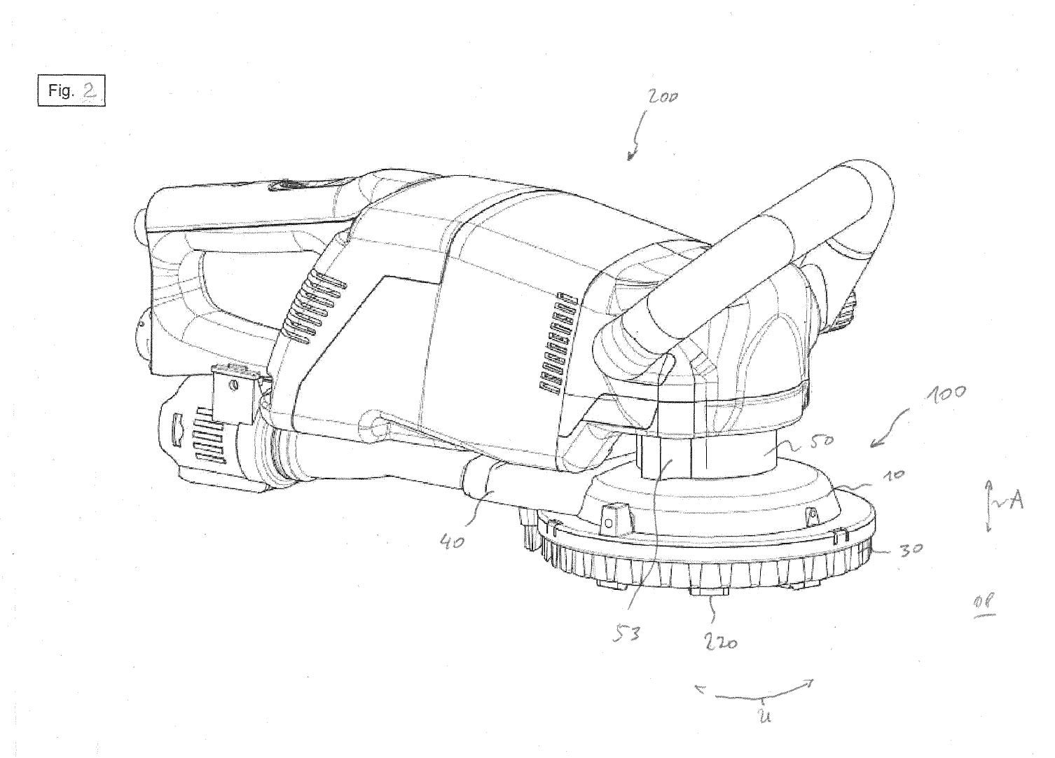

FIG. 2 shows a perspective illustration of the exemplary embodiment in FIG. 1;

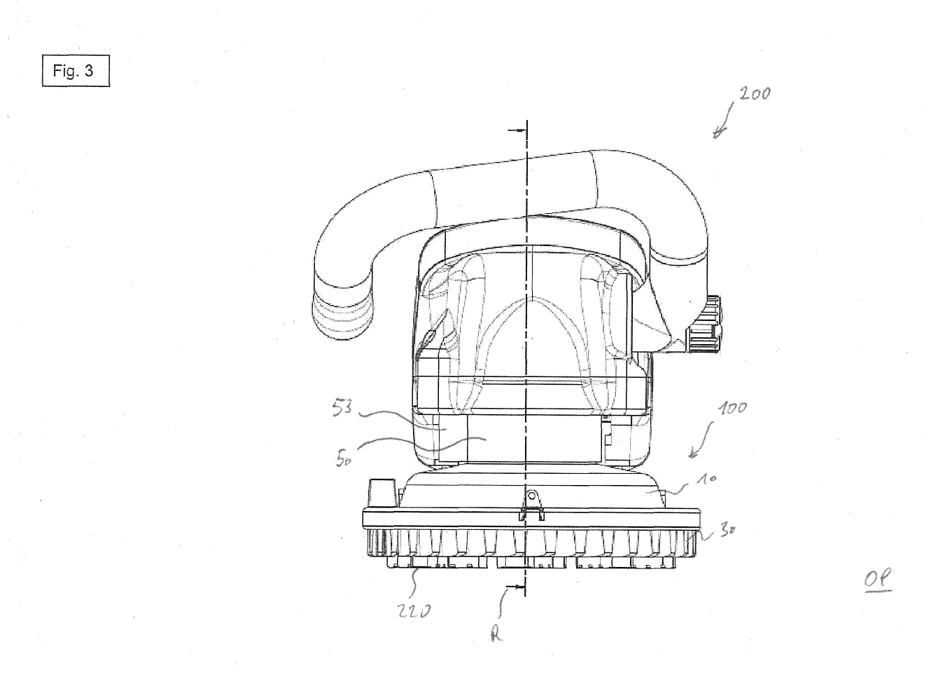

FIG. 3 shows a front view of the exemplary embodiment in FIGS. 1 and 2;

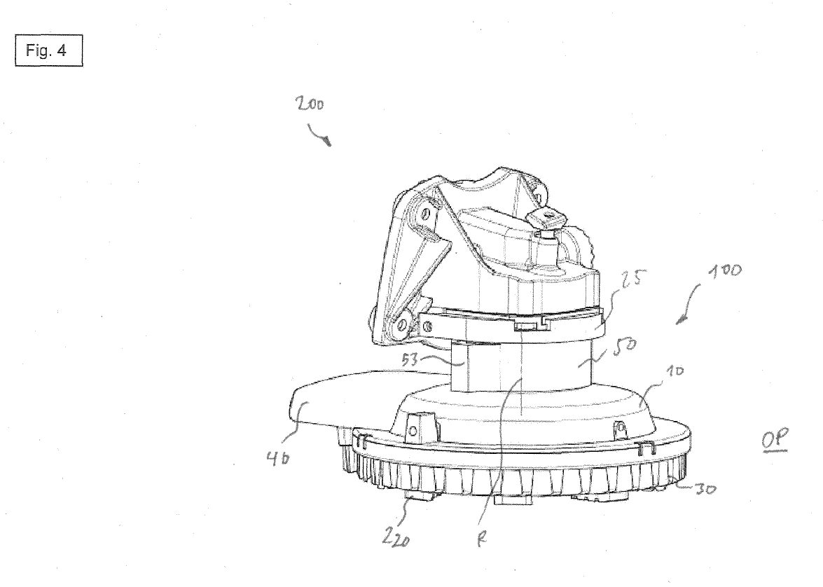

FIG. 4 shows the dust hood in FIGS. 1 through 3 in the upper hood position, with only a portion of the grinding device illustrated;

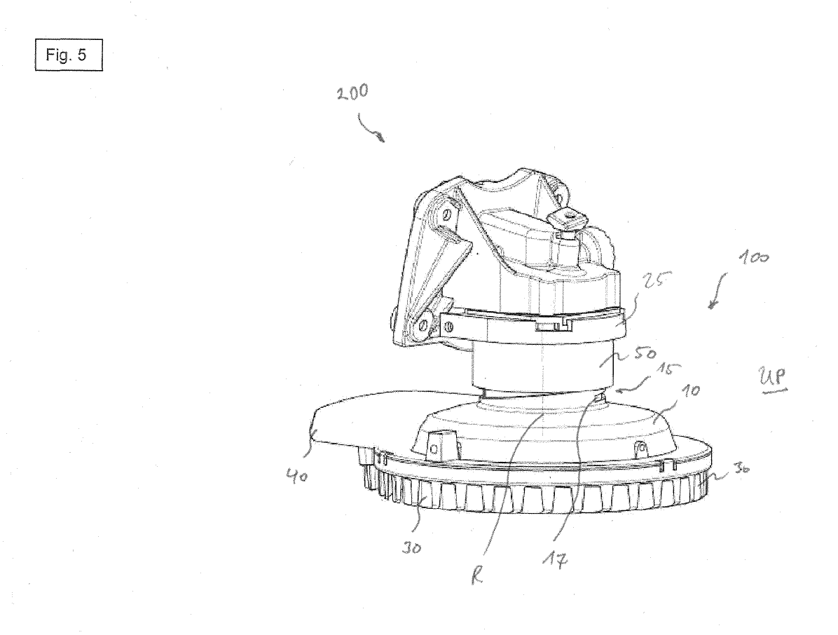

FIG. 5 shows the dust hood in FIGS. 1 through 4 in the lower hood position, with only a portion of the grinding device illustrated;

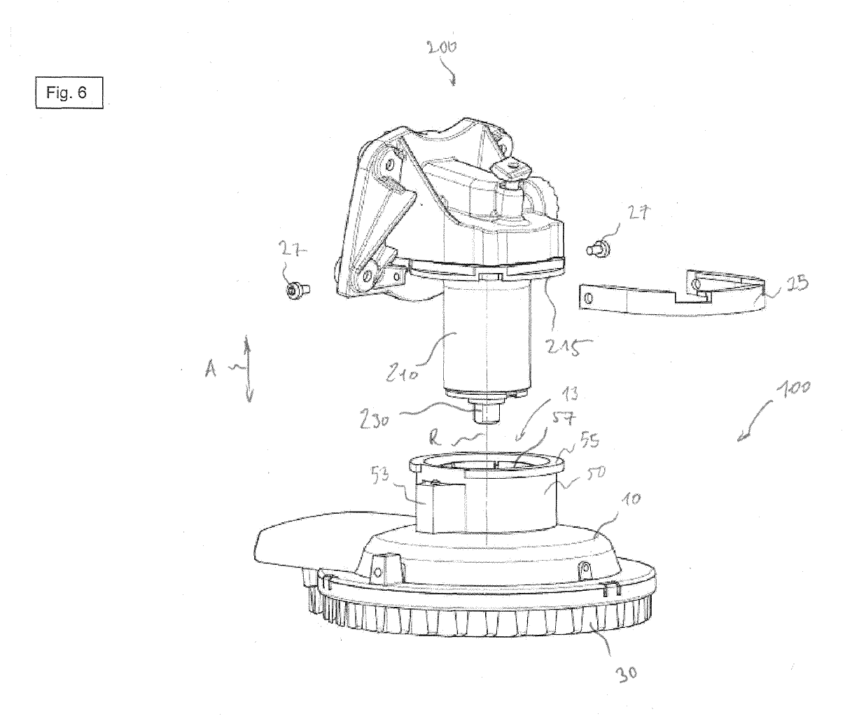

FIG. 6 shows the dust hood in FIGS. 1 through 5 in the removed state, with only a portion of the grinding device illustrated;

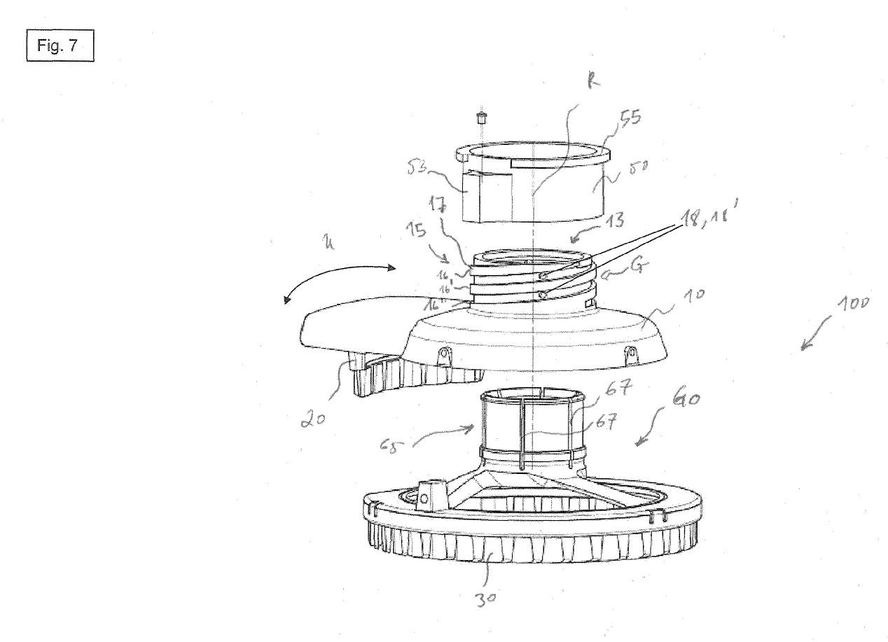

FIG. 7 shows the dust hood in FIGS. 1 through 6 in a partially opened state, with the grinding device not illustrated; and

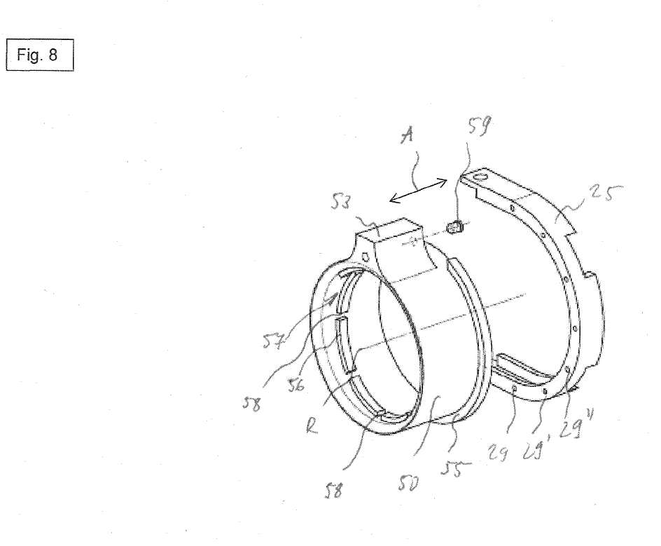

FIG. 8 shows a preferred embodiment of the adjusting ring and the wraparound piece.

### EXEMPLARY EMBODIMENT

FIG. 1 shows a grinding device 100 in the form of a diamond grinder. The grinding device 200 has a gearbox extension 210 for attaching a dust hood 100, which is likewise illustrated in FIG. 1. The dust hood 100 is illustrated in a sectional view for reasons of clarity.

The dust hood 100 is equipped with a hood body 10 for covering a circular grinding disk 220, in the present case a diamond disk, and with a skirt 30 extending along a periphery U of the hood body 10 for at least partially sealing the hood body 10 with respect to a surface UG that is to be machined by means of the grinding disk 220. The skirt 30 is designed as a lamellar skirt.

Removed surface material S in the form of dust can be suctioned from the hood body 10 via a suction connection 40 of the dust hood 100.

The hood body 10 in FIG. 1 is designed for covering a major portion of the grinding disk 220, the dust hood 100 having a hood section 20 that is movable along the hood body 10 in the circumferential direction U of the hood body 10, and that is provided for gradually covering and uncovering a remaining portion 220′ of the grinding disk 220 as needed. A skirt 30′ in the form of a lamellar skirt is likewise provided in the hood section 20. Grinding may also be carried out on a vertical wall by uncovering the remaining portion 220′ of the grinding disk 220.

According to the invention, the dust hood 100 has an adjusting ring 50 by means of which the hood body 10 may be adjusted in the axial direction A relative to the gearbox extension 210 and the adjusting ring 50, with respect to the rotational axis R of the grinding disk 220.

The adjusting ring 50 is connected to the gearbox extension 210 of the grinding device 200 in a form-fit manner in the axial direction A. This is achieved by a U-shaped wraparound piece 25 (also see FIGS. 6 and 8) that encompasses a retaining collar 55, provided on the adjusting ring 50, for securing the adjusting ring 50 to the gearbox extension 210. In the proper arrangement of the dust hood 100 on the grinding device 200 shown in FIG. 1, the wraparound piece 25 likewise encompasses a housing collar 215 that is provided on the gearbox extension 210.

The hood body 10 has a central opening 13 through which the gearbox extension 210 may extend or protrude. A drive spindle (not shown) to which the circular grinding disk 220 is attached for the grinding operation is guided through the gearbox extension 210.

The adjustability of the hood body 10 is explained in greater detail below.

As is apparent from FIG. 1, the adjusting ring 50 includes a guide neck 15 that is formed on the outside of the hood body 10.

An adjustment thread 57 has a thread pitch G that is formed on the inner side of the adjusting ring 50 (see FIG. 7), the adjustment thread engaging with a corresponding adjustment thread 17 formed on the outer side of the guide neck 15. As a result, rotating the adjusting ring 50 about the rotational axis R causes raising or lowering of the hood body 10 relative to the gearbox extension 210 and of the hood body 10 relative to the adjusting ring 50.

FIG. 2 shows a perspective illustration of the exemplary embodiment in FIG. 1. It is clearly apparent in FIG. 2 that the adjusting ring 50 has a grip piece 53 to facilitate operation of the adjusting ring 30.

The hood body 10 is adjustable from an upper hood position OP (FIG. 1 through FIG. 4) into a lower hood position UP (FIG. 5) and vice versa by rotating the adjusting ring 50 by approximately 180 degrees, wherein the upper and lower hood positions each define a stop. FIG. 2 shows an upper hood position OP of the hood body 10, for which reason the grinding disk 220 has a maximum projection beyond the hood body 10, relative to the axial direction A.

FIG. 3 illustrates a front view of the exemplary embodiment in FIGS. 1 and 2.

FIG. 4 shows the dust hood in FIGS. 1 through 3 once again, in the upper hood position OP, with only a portion of the grinding device 200 illustrated. The U-shaped wraparound piece 25 is clearly apparent.

FIG. 5 shows the dust hood in FIGS. 1 through 4 in the lower hood position UP, likewise with only a portion of the grinding device illustrated. A portion of the corresponding adjustment thread 17 that is formed on the outer side of the guide neck 15 is discernible below the adjusting ring 50.

FIG. 6 illustrates the dust hood in FIGS. 1 through 5 in the removed state, with only a portion of the grinding device 200 illustrated. The wraparound piece 25, which is provided so as to be removable from the gearbox extension 210 transversely, preferably perpendicularly, with respect to the rotational axis R, is shown in the removed state in FIG. 6. Two retaining screws 27, provided for securing the wraparound piece 25 against removal from the gearbox extension 210, are detached in the present case. According to one alternative embodiment, the two retaining screws 27 may also have a design in the form of two retaining pins. It is also possible for the two retaining screws 27 to be implemented by two rivets.

Clearly apparent in FIG. 6 are the retaining collar 55 that is provided on the adjusting ring 50, and the housing collar 215 that is provided on the gearbox extension 210, which are retained by the wraparound piece 25 in a form-fit manner in the axial direction A when the wraparound piece 25 is mounted, with the adjusting ring 50 remaining rotatable.

The hood body 10 has a central opening 13 through which the gearbox extension 210 may extend or protrude. A drive spindle 230 to which the circular grinding disk (not shown) is attached for the grinding operation is guided through the gearbox extension 210. A portion of the adjustment thread 57 that is formed on the inner side of the guide neck 15 is discernible on the upper inner side of the adjusting ring 50.

FIG. 7 illustrates the dust hood 100 in FIGS. 1 through 6 in the partially opened state; the grinding device is not illustrated. In particular, a measure for effectively suctioning out removed surface material (dust) is apparent in FIG. 7.

A core recess 18, 18′ is provided in each case between two adjoining threads 16, 16′; 16′, 16″ of the corresponding adjustment thread 17. The core recesses 18, 18′ are designed as through holes to the interior of the guide neck 15. Dust may be suctioned from the corresponding adjustment thread 17 through the core recesses 18, 18′.

As is apparent in the lower portion of FIG. 7, the dust hood 100 has a skirt support 60 to which the skirt 30 is fixedly connected, the skirt support 60 having a detent socket 65 that can be snapped into the hood body 10 or into the guide neck 15. In the exemplary embodiment illustrated here, the detent socket 65 has six socket slots 67 that extend in parallel to the rotational axis R. The skirt support 60 and the dust hood 10 may be put together in such a way that one of the socket slots 67 at least partially overlaps with the core recess 18. This allows optimal suction of dust from the corresponding adjustment thread 17.

Lastly, FIG. 8 shows one preferred embodiment of the adjusting ring 50 and the wraparound piece 25. For the purpose of adjustability of the height of the hood body (not shown) in steps, a preferably spring-mounted locking tappet 59 is provided on the adjusting ring 50. A plurality of recesses 29, 29′, 29″, each corresponding to a height step, is provided on the wraparound piece 25. As is likewise apparent from FIG. 8, multiple threaded recesses 58 that define a continuous thread 56 are provided in the thread 56 of the adjustment thread 57. Knocking off undesirable encrusted dust is facilitated in this way.

1. A dust hood for a grinding device equipped with a gearbox extension for attaching the dust hood, the dust hood having a hood body for covering a circular grinding disk, and having a skirt extending along a periphery (U) of the hood body for at least partially sealing the hood body with respect to a surface (UG) that is to be machined by the grinding disk, and having a suction connection via which removed surface material can be suctioned from the hood body,
wherein the dust hood has an adjusting ring by which the hood body may be adjusted relative to the gearbox extension and/or to the adjusting ring, with respect to a rotational axis (R) of the grinding disk.

2. The dust hood according to claim 1, wherein the hood body has an outside and the adjusting ring includes a guide neck formed on the outside of the hood body.

3. The dust hood according to claim 2, wherein the adjusting ring has an inner side and the guide neck has an outer side and an adjustment thread having a thread pitch (G) is formed on the inner side of the adjusting ring, the adjustment thread engaging with a corresponding adjustment thread formed on the outer side of the guide neck such that rotating the adjusting ring about the rotational axis (R) causes raising or lowering of the hood body relative to the gearbox extension and/or of the hood body relative to the adjusting ring.

4. The dust hood according to claim 1, wherein the dust hood has a wraparound piece that encompasses a retaining collar, provided on the adjusting ring, for securing the adjusting ring to the gearbox extension, and when the dust hood is mounted on the grinding device, the wraparound piece likewise encompasses a housing collar provided on the gearbox extension.

5. The dust hood according to claim 5, wherein the wraparound piece is removable from the gearbox extension) transversely, with respect to the rotational axis (R).

6. The dust hood according to claim 5, wherein the wraparound piece is secured against removal from the gearbox extension by at least one retaining screw and/or a lock.

7. The dust hood according to claim 1, wherein the hood body is infinitely adjustable.

8. The dust hood according to claim 4, wherein the hood body is adjustable by steps, the adjusting ring including a spring-mounted locking tappet provided on the adjusting ring, and a plurality of recesses that each correspond to a height step provided on the wraparound piece.

9. The dust hood according to claim 1, wherein the hood body is adjustable from an upper hood position (OP) into a lower hood position (UP) and vice versa by rotating the adjusting ring by approximately 180 degrees, wherein the upper and lower hood positions (UP; OP) each define a stop.

10. The dust hood according to claim 1, wherein the adjusting ring is connected to the gearbox extension of the grinding device in a form-fit manner in an axial direction (A).

11. The dust hood according to claim 3, wherein at least one threaded recess is provided in a thread of the adjustment thread, and/or at least one core recess is provided between two adjoining threads of a corresponding adjustment thread.

12. The dust hood according to claim 1, wherein the dust hood has a skirt support to which the skirt is fixedly connected, the skirt support having a detent socket that can be snapped into the hood body.

13. The dust hood according to claim 11, wherein the detent socket has at least one socket slot that extends in parallel to the rotational axis (R) and that overlaps with the at least one core recess.

14. The dust hood according to claim 1, wherein the hood body is designed for covering a major portion of the grinding disk, and the dust hood has a hood section that is movable along the hood body in a circumferential direction (U) of the hood body, and that is provided for gradually covering and uncovering a remaining portion of the grinding disk as needed, and wherein a skirt is likewise provided in the hood section.

15. The dust hood according to claim 1, wherein the skirt is fixedly connected to the hood body, and the dust hood is free of any spring elements that act between the skirt and the hood body in an axial direction (A).

16. A grinding device having a gearbox extension and a dust hood according to claim 1, wherein the dust hood is or may be situated on the gearbox extension.

17. The dust hood according to claim 1, wherein the hood body may be adjusted relative to the gearbox extension and/or the adjusting ring in an axial direction (A) with respect to the rotational axis (R) of the grinding disk.

18. The dust hood according to claim 4, wherein the wraparound piece is U-shaped.

19. The dust hood according to claim 5, wherein the wraparound piece is removable from the gearbox extension perpendicularly with respect to the rotational axis (R).

20. The dust hood according to claim 2, wherein the dust hood has a wraparound piece that encompasses a retaining collar, provided on the adjusting ring, for securing the adjusting ring to the gearbox extension, and when the dust hood is properly mounted on the grinding device, the wraparound piece likewise encompasses a housing collar provided on the gearbox extension.
